(19) United States
(12) Patent Application Publication
(10) Pub. No.: US 2012/0063001 A1
(43) Pub. Date: Mar. 15, 2012

(54) ZOOM LENS SYSTEM

(75) Inventor: Masakazu SAORI, Saitama (JP)

(73) Assignee: HOYA CORPORATION, Tokyo (JP)

(21) Appl. No.: 13/188,749

(22) Filed: Jul. 22, 2011

(30) Foreign Application Priority Data
Sep. 13, 2010 (JP) 2010-204231

(51) Int. Cl. G02B 15/177

(52) U.S. Cl. 359/680

(57) ABSTRACT

A zoom lens system includes a negative first lens group, a positive second lens group, and a positive third lens group, in that order from the object side. Upon zooming from the short to long focal length extremities, the first through third lens groups move along an optical axis direction so that the distance between the first and second lens groups decreases, and the distance between the second and third lens groups increases. The first lens group includes a negative glass lens element and at least two plastic lens elements, in that order from the object side, and wherein the following condition (1) is satisfied:
|f1/f1pc|<0.04 . . . (1), wherein f1 designates the focal length of the first lens group, and f1pc designates the combined focal length of the plastic lens elements that are provided within the first lens group.

### BACKGROUND OF THE INVENTION

1. Field of the Invention

The present invention relates to a low-cost zoom lens system having a zoom ratio of approximately 6:1 for use in a compact, light-weight digital camera, etc.

2. Description of Related Art

Due to the rapid popularization of digital cameras in recent years, demands are being made for lower-cost digital cameras, and also there is a strong demand for a lower-cost photographic optical system therefor. In addition, there is a tendency for a compact digital camera to be desired to be highly compact, and hence further miniaturization and a further decrease in weight of the camera is desired. Whereas, the number of pixels of solid-state image sensors, such as a CCD, etc., has been increasing year after year, so that a high-quality photographic optical system which is compatible with such fineness of pixel pitch is in demand.

A positive-lead lens system is often used in zoom lens systems for compact digital cameras having a zoom ratio of approximately 6:1. Although a positive-lead lens system is advantageous for ensuring a high zoom ratio, there is the disadvantage of the number of lens elements thereof being large, easily incurring a high cost. Whereas, in a zoom lens system having a zoom ratio of approximately 3:1 through 4:1, a negative-lead lens system is often used. A negative-lead lens system has a small number of lens elements, which is advantageous in regard to providing a low-cost zoom lens system, and since the lens system can be miniaturized, especially the frontmost lens diameter, is suitable for application in a retractable zoom lens camera which decreases the distances between the lens groups thereof while being retracted to an accommodation position. However, it is difficult to increase the zoom ratio in such a negative-lead lens system.

Negative-lead zoom lens systems such as, for example, Japanese Unexamined Patent Publication Nos. 2010-91948, 2003-50352, and H09-21950 are known in art. In the above-mentioned Japanese Unexamined Patent Publication No. 2010-91948, a negative-lead zoom lens system is disclosed as achieving a zoom ratio of approximately 5:1, however, since a large number of glass lens elements are employed, the cost cannot be kept sufficiently low. Furthermore, in the above-mentioned Japanese Unexamined Patent Publication Nos. 2003-50352 and H09-21950, cost reduction is achieved by employing a large number of plastic lens elements, however, the zoom ratio is approximately 3:1, which is insufficient, and furthermore, it cannot be said that sufficient consideration has been given with regard to environmental resistance.

### SUMMARY OF THE INVENTION

The present invention provides a zoom lens system having a negative-lead lens arrangement while achieving a zoom ratio of approximately 6:1 while also having an excellent cost performance and environmental resistance.

According to an aspect of the present invention, a zoom lens system is provided, including a negative first lens group, a positive second lens group, and a positive third lens group, in that order from the object side. Upon zooming from the short focal length extremity to the long focal length extremity, the first through third lens groups move along an optical axis direction so that the distance between the first lens group and the second lens group decreases, and the distance between the second lens group and the third lens group increases. The first lens group includes a negative glass lens element and at least two plastic lens elements, in that order from the object side, and wherein the following condition (1) is satisfied:

|f1/f1pc|<0.04 . . . (1), wherein f1 designates the focal length of the first lens group, and f1pc designates the combined focal length of the plastic lens elements that are provided within the first lens group.

It is desirable for the following condition (2) to be satisfied:

0.015<Σ(φ1i/v1i)<0.025 . . . (2), wherein φ1i designates the refractive power (=1/f1i) of the i^{th} lens element of the plastic lens elements which are provided in the first lens group, v1i designates the Abbe number with respect to the d-line of the i^{th} lens element of the plastic lens elements which are provided in the first lens group, and f1i designates the focal length of the i^{th} lens element of the plastic lens elements which are provided in the first lens group.

It is desirable for the first lens group to include a negative glass lens element, a negative plastic lens element, and a positive plastic lens element, in that order from the object side, wherein the following condition (3) is satisfied:

−8.0<R1/R2<−3.0 . . . (3), wherein R1 designates the radius of curvature of the surface on the object side of the glass lens element which is provided closest to the object side within the first lens group, and R2 designates the radius of curvature of the surface on the image side of the glass lens element which is provided closest to the object side within the first lens group.

It is desirable for the second lens group to include a positive glass lens element and at least two plastic lens elements, in that order from the object side, and wherein the following condition (4) is satisfied:

−0.25<f2/f2pc<−0.05 . . . (4), wherein f2 designates the focal length of the second lens group, and f2pc designates the combined focal length of the plastic lens elements that are provided within the second lens group.

It is desirable for the following condition (5) to be satisfied:

v21>80 . . . (5), wherein v21 designates the Abbe number with respect to the d-line of the glass lens element which is provided closest to the object side within the second lens group.

It is desirable for the following condition (6) to be satisfied:

−0.005<Σ(φ2i/v2i)<−0.002 . . . (6), wherein φ2i designates the refractive power (=1/f2i) of the i^{th} lens element of the plastic lens elements which are provided in the second lens group, v2i designates the Abbe number with respect to the d-line of the i^{th} lens element of the plastic lens elements which are provided in the second lens group, and f2i designates the focal length of the i^{th} lens element of the plastic lens elements which are provided in the second lens group.

It is desirable for the third lens group to be a single plastic lens element having a positive refractive power, and wherein the following condition (7) is satisfied:

−5.0<f2pc/f3<−2.0 . . . (7), wherein f2pc designates the combined focal length of the plastic lens elements which are provided in the second lens group, and f3 designates the focal length of the third lens group (which is the single plastic lens element).

According to the present invention, a zoom lens system having a negative-lead lens arrangement while providing a zoom ratio of approximately 6:1 while also having an excellent cost performance and environmental resistance is achieved.

The present disclosure relates to subject matter contained in Japanese Patent Application No. 2010-204231 (filed on Sep. 13, 2010) which is expressly incorporated herein in its entirety.

### BRIEF DESCRIPTION OF THE DRAWINGS

The present invention will be discussed below in detail with reference to the accompanying drawings, in which:

FIG. 1 shows a lens arrangement of a first numerical embodiment of a zoom lens system, according to the present invention, at the long focal length extremity when focused on an object at infinity;

FIGS. 2A, 2B, 2C and 2D show various aberrations that occurred in the lens arrangement shown in FIG. 1;

FIG. 3 shows a lens arrangement of the first numerical embodiment of the zoom lens system, according to the present invention, at the short focal length extremity when focused on an object at infinity;

FIGS. 4A, 4B, 4C and 4D show various aberrations that occurred in the lens arrangement shown in FIG. 3;

FIG. 5 shows a lens arrangement of a second numerical embodiment of a zoom lens system, according to the present invention, at the long focal length extremity when focused on an object at infinity;

FIGS. 6A, 6B, 6C and 6D show various aberrations that occurred in the lens arrangement shown in FIG. 5;

FIG. 7 shows a lens arrangement of the second numerical embodiment of the zoom lens system, according to the present invention, at the short focal length extremity when focused on an object at infinity;

FIGS. 8A, 8B, 8C and 8D show various aberrations that occurred in the lens arrangement shown in FIG. 7;

FIG. 9 shows a lens arrangement of a third numerical embodiment of a zoom lens system, according to the present invention, at the long focal length extremity when focused on an object at infinity;

FIGS. 10A, 10B, 10C and 10D show various aberrations that occurred in the lens arrangement shown in FIG. 9;

FIG. 11 shows a lens arrangement of the third numerical embodiment of the zoom lens system, according to the present invention, at the short focal length extremity when focused on an object at infinity;

FIGS. 12A, 12B, 12C and 12D show various aberrations that occurred in the lens arrangement shown in FIG. 11;

FIG. 13 shows a zoom path of the zoom lens system according to the present invention.

### DESCRIPTION OF THE EMBODIMENTS

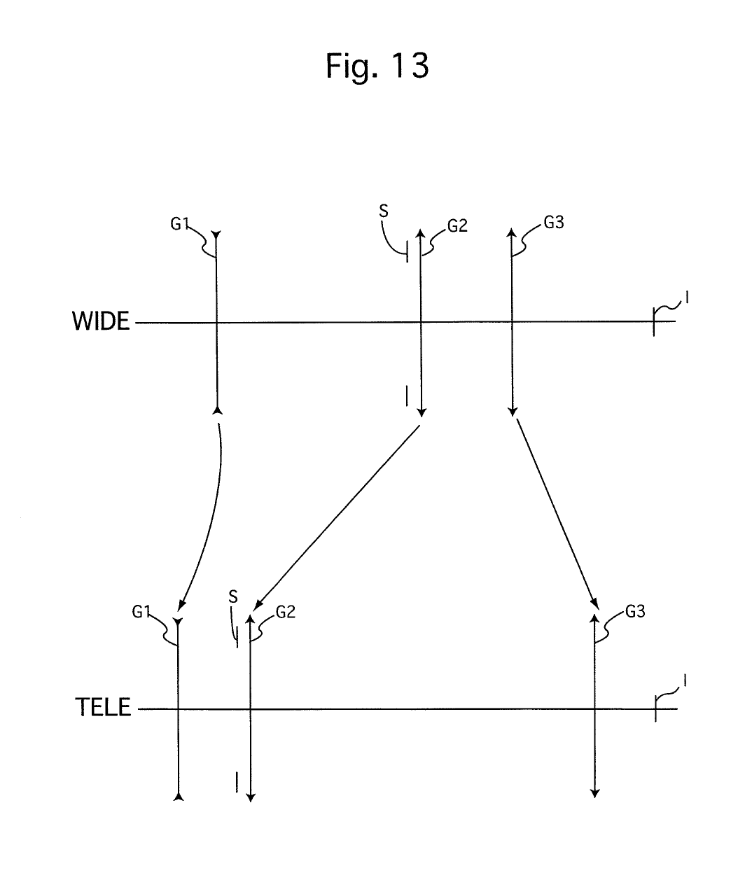

The zoom lens system according to the present invention, as shown in the zoom path of FIG. 13, is configured of a negative first lens group G1, a positive second lens group G2 and a positive third lens group G3, in that order from the object side. A diaphragm S, which is positioned on an orthogonal plane (with respect to the optical axis) that is tangent to the surface on the object side of the second lens group G2 (the diaphragm S is illustrated in FIG. 13 at a position slightly away from the object side of the second lens group G2), integrally moves with the second lens group G2 along the optical axis during zooming. ‘I’ designates the imaging plane. The third lens group G3 constitutes a focusing lens group which is moved during a focusing operation (the third lens group G3 is advanced toward the object side upon carrying out a focusing operation on an object at infinity to an object at a finite distance).

The zoom lens system, upon zooming from the short focal length extremity (WIDE) to the long focal length extremity (TELE), moves the first through third lens groups G1 through G3 in the optical axis direction while reducing the distance between the first and second lens groups G1 and G2, and increasing the distance between the second and third lens groups G2 and G3.

More specifically, in each of the first through third numerical embodiments, upon zooming from the short focal length extremity to the long focal length extremity, the first lens group G1 moves, overall, toward the object side while plotting a convex moving path, the second lens group G2 monotonically moves toward the object side, and the third lens group G3 moves monotonically toward the image side.

In each of the first through third numerical embodiments, the first lens group G1 is configured of a negative lens element 11, a negative lens element 12, and a positive lens element 13, in that order from the object side. The negative lens element 11 is formed from a glass lens material. The negative lens element 12 and the positive lens element 13 are each formed from a plastic lens material.

In the first numerical embodiment, the second lens group G2 is configured of a positive lens element 21, a positive lens element 22, and a negative lens element 23, in that order from the object side. The positive lens element 21 is a glass lens element formed from a specialized low-dispersion glass (ED glass) having an Abbe number with respect to the d-line exceeding 80. The positive lens element 22 and the negative lens element 23 are plastic lens elements.

In each of the second and third numerical embodiments, the second lens group is configured of a positive lens element 21′, a cemented lens formed from a positive lens element 22′ and a negative lens element 23′, and a negative lens element 24′, in that order from the object side. The positive lens element 21′ is a glass lens element formed from a specialized low-dispersion glass (ED glass) having an Abbe number with respect to the d-line exceeding 80. The positive lens element 22′, the negative lens element 23′ and the negative lens element 24′ are plastic lens elements.

In each of the first through third numerical embodiments, the third lens group G3 is configured of a single plastic lens element 31 having a positive refractive power.

If the zoom ratio of a negative-lead zoom lens system configured of a negative lens group, a positive lens group and a positive lens group, like that of the present invention, is increased, the lateral magnification at the long focal length extremity from the second lens group rewards (i.e., the second lens group and the third lens group) increases, and accordingly, aberrations that occur at the first lens group are magnified.

Furthermore, if a large number of plastic lens elements are employed in order to reduce the cost and reduce the weight of the zoom lens system, it becomes a problem to reduce the change in optical quality due to a change in temperature in the first lens group, i.e., the adverse influence (deterioration in the optical quality) of aberration corrections and temperature change upon the magnified aberrations becoming prominent, since plastic lens elements are susceptible to being influenced by temperature change (has an inferior environmental resistance).

Whereas, the lens element (negative lens element 11) which is provided closest to the object side within the first lens group G1 is the most important lens element with regard to optical quality, and since physical stability, together with (of course) aberration corrections, are demanded in this lens element 11, it is desirable for this lens element 11 to be formed from a glass lens material.

Consequently, in the present invention, a glass lens element 11 having a negative refractive power is provided closest to the object side within the first lens group G1, and at least two plastic lens elements are provided on the image side of this negative glass lens element 11.

Condition (1) specifies the ratio of the focal length of the first lens group G1 to the combined focal length of the plastic lens elements that are provided within the first lens group G1, and achieves correction of aberrations and reduces the influence of a change in temperature.

If the upper limit of condition (1) is exceeded, the combined refractive power of the plastic lens elements within the first lens group G1 becomes too strong, so that the change in optical quality due to a change in temperature becomes great, which is undesirable.

Condition (2) specifies the ratio of the refractive power to the Abbe number with respect to the d-line of the plastic lens elements provided within the first lens group G1, and achieves favorable correction of chromatic aberration.

If the upper limit of condition (2) is exceeded, the chromatic aberration occurring in the glass lens element 11 which is provided closest to the object side within the first lens group G1 cannot be favorably corrected.

If the lower limit of condition (2) is exceeded, the chromatic aberration becomes overcorrected, which is undesirable.

As mentioned above, in each of the first through third embodiments, the first lens group G1 is configured of a negative glass lens element 11, a negative plastic lens element 12, and a positive plastic lens element 13, in that order from the object side.

In regard to this configuration, condition (3) specifies the radius of curvature of the glass lens element 11, which is provided closest to the object side within the first lens group G1, and achieves reduction in the occurrence of aberrations.

If the upper limit of condition (3) is exceeded, the curvature of the surface on the object side of the glass lens element 11, which is provided closest to the object side within the first lens group G1, becomes too small (in other words, the radius of curvature thereof becomes too large), so that large amounts of distortion/astigmatism occur at the short focal length extremity.

If the lower limit of condition (3) is exceeded, the curvature of the surface on the image side of the glass lens element 11, which is provided closest to the object side within the first lens group G1, becomes too small (in other words, the radius of curvature thereof becomes too large), so that large amounts of spherical aberration/coma occur at the long focal length extremity.

As described above, in each of the first through third embodiments, the second lens group G2 is configured of a positive glass lens element, and at least two plastic lens elements, in that order from the object side.

Condition (4) specifies the ratio of the focal length of the second lens group G2 to the combined focal length of the plastic lens elements which are provided within the second lens group G2, and achieves correction of aberrations and reduces the influence of a change in temperature.

If the upper limit of condition (4) is exceeded, the combined negative refractive power of the plastic lens elements provided within the second lens group G2 becomes too weak, so that aberrations that occur due to the positive refractive power of the glass lens element which is provided closest to the object side within the second lens group G2 cannot be favorably corrected.

If the lower limit of condition (4) is exceeded, the combined negative refractive power of the plastic lens elements provided within the second lens group G2 becomes too strong, so that the change in optical quality due to a change in temperature undesirably increases.

Condition (5) specifies the Abbe number with respect to the d-line of the glass lens element which is provided closest to the object side within the second lens group G2, and achieves favorable correction of chromatic aberration, especially at the long focal length extremity.

If the lower limit of condition (5) is exceeded, since chromatic aberration, especially at the long focal length extremity, cannot be favorably corrected, it becomes difficult to achieve a high zoom ratio while ensuring an acceptable optical quality.

Condition (6) specifies the ratio of the refractive power to the Abbe number with respect to the d-line of the plastic lens elements provided within the second lens group G2, and achieves favorable correction of chromatic aberration, especially at the long focal length extremity.

If the upper limit of condition (6) is exceeded, the chromatic aberration occurring in the glass lens element 21 which is provided closest to the object side within the second lens group G2 cannot be favorably corrected.

If the lower limit of condition (6) is exceeded, the chromatic aberration becomes overcorrected, which is undesirable.

As described above, in each of the first through third embodiments, the third lens group G3 is configured of a single plastic lens element 31 having a positive refractive power; therefore, the overall cost of the zoom lens system can be lowered.

Condition (7), with regard to the above-described configuration, specifies the ratio of the combined focal length of the plastic lens elements which are provided within the second lens group G2 to the focal length of the third lens group G3 (which is a single plastic lens element 31), and reduces the influence of a change in temperature.

If the upper limit of condition (7) is exceeded, the positive refractive power of the third lens group G3 becomes too weak, so that the influence (deterioration in the optical quality) due to the change in temperature that occurs in the plastic lens element which is provided within the second lens group G2 cannot be favorably corrected at the third lens group G3.

If the lower limit of condition (7) is exceeded, the positive refractive power of the third lens group G3 becomes too strong, so that the influence (deterioration in the optical quality) of the change in temperature that occurs in the plastic lens elements provided within the second lens group G2 becomes overcorrected at the third lens group G3, which is undesirable.

### Embodiments

Specific numerical embodiments will be herein discussed. The following numerical embodiments are applied to a zoom lens system used in a compact digital camera. In the aberration diagrams and the tables, the d-line, the g-line and the C-line show aberrations at their respective wave-lengths; S designates the sagittal image, M designates the meridional image, FNO. designates the f-number, f designates the focal length of the entire optical system, W designates the half angle of view (°), Y designates the image height, fB designates the backfocus, L designates the overall length of the lens system, r designates the radius of curvature, d designates the lens thickness or distance between lenses, N(d) designates the refractive index at the d-line, and υd designates the Abbe number with respect to the d-line. The values for the f-number, the focal length, the half angle-of-view, the image height, the backfocus, the overall length of the lens system, and the distance between lenses (which changes during zooming and according to the overall length of the lens system) are shown in the following order: short focal length extremity, intermediate focal length, and long focal length extremity.

An aspherical surface which is rotationally symmetrical about the optical axis is defined as:

x=cy²/(1+[1−{1+K}c²y²]^{1/2})+A4y⁴+A6y⁶+A8+y⁸+A10y¹⁰+A12y¹²

wherein ‘x’ designates a distance from a tangent plane of the aspherical vertex, ‘c’ designates the curvature (1/r) of the aspherical vertex, ‘y’ designates the distance from the optical axis, ‘K’ designates the conic coefficient, A4 designates a fourth-order aspherical coefficient, A6 designates a sixth-order aspherical coefficient, A8 designates an eighth-order aspherical coefficient, A10 designates a tenth-order aspherical coefficient, and A12 designates a twelfth-order aspherical coefficient.

### Embodiment 1

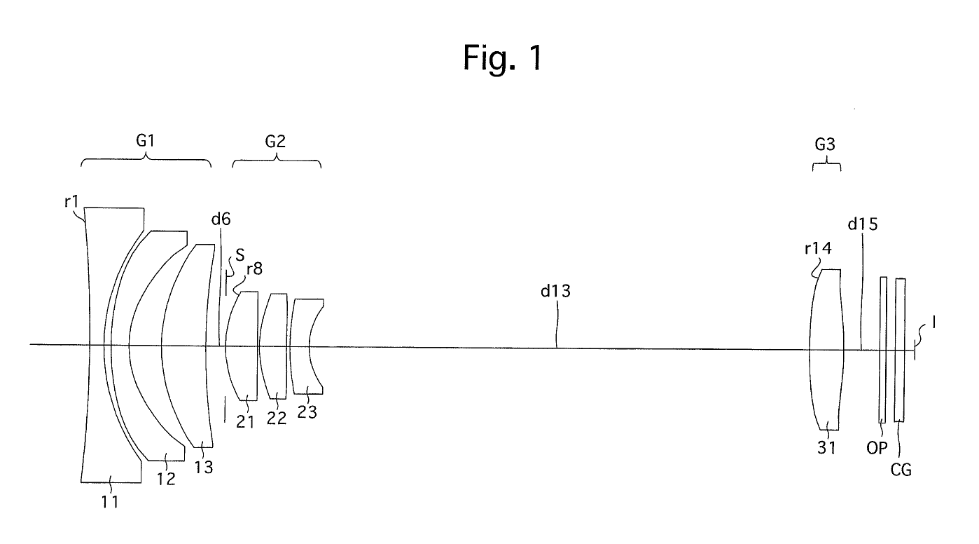

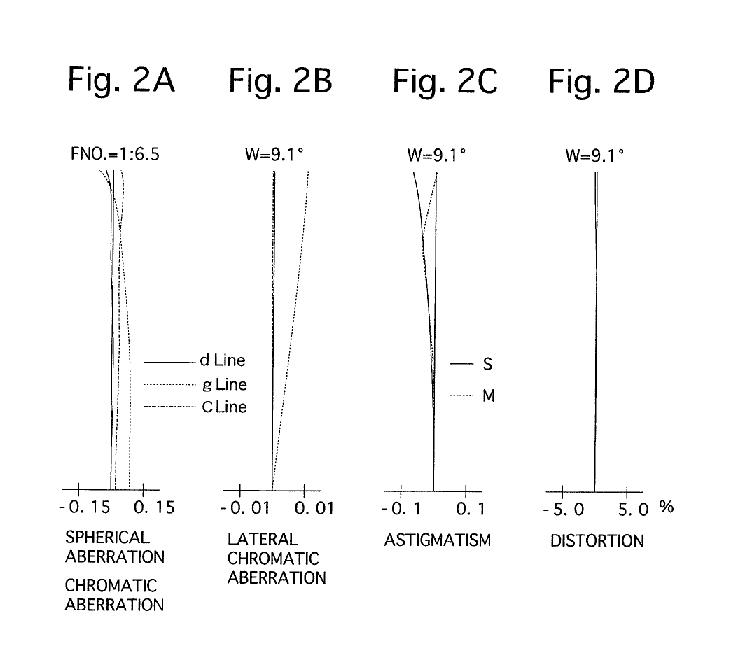

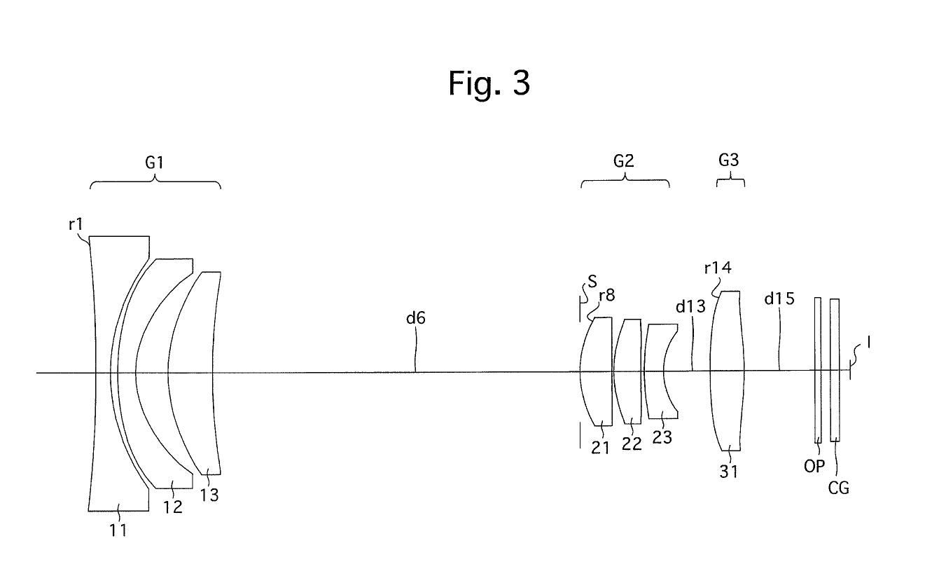

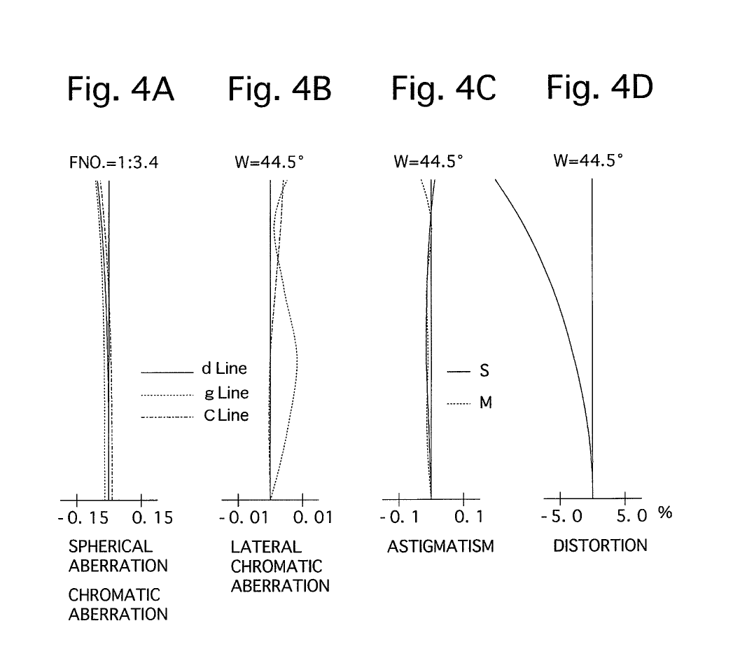

FIGS. 1 through 4D and Tables 1 through 4 show a first numerical embodiment of a zoom lens system according to the present invention. FIG. 1 shows a lens arrangement of the first numerical embodiment of the zoom lens system at the long focal length extremity when focused on an object at infinity. FIGS. 2A, 2B, 2C and 2D show various aberrations that occurred in the lens arrangement shown in FIG. 1. FIG. 3 shows a lens arrangement of the first numerical embodiment of the zoom lens system at the short focal length extremity when focussed on an object at infinity. FIGS. 4A, 4B, 4C and 4D show various aberrations that occurred in the lens arrangement shown in FIG. 3. Table 1 shows the lens surface data, Table 2 shows various zoom lens system data, Table 3 shows the aspherical surface data, and Table 4 shows the lens group data of the zoom lens system according to the first numerical embodiment.

The zoom lens system of the first numerical embodiment is configured of a negative first lens group G1, a positive second lens group G2, and a positive third lens group G3, in that order from the object side. The third lens group G3 constitutes a focusing lens group that is moved along the optical axis direction during a focusing operation (the third lens group G3 advances toward the object side when performing a focusing operation while focusing on an object at infinity to an object at a finite distance).

The first lens group G1 (surface Nos. 1 through 6) is configured of a biconcave negative lens element 11, a negative meniscus lens element 12 having a convex surface on the object side, and a positive meniscus lens element 13 having a convex surface on the object side, in that order from the object side. The biconcave negative lens element 11 is a glass lens element. The negative meniscus lens element 12 is a plastic aspherical lens element having an aspherical surface on each side thereof. The positive meniscus lens element 13 is a plastic aspherical lens element having an aspherical surface on the object side.

The second lens group G2 (surface Nos. 8 through 13) is configured of a positive meniscus lens element 21 having a convex surface on the object side, a positive meniscus lens element 22 having a convex surface on the object side, and a negative meniscus lens element 23 having a convex surface on the object side, in that order from the object side. The positive meniscus lens element 21 is a glass lens material that is formed from a specialized low-dispersion glass (ED glass) having an Abbe number with respect to the d-line exceeding 80. The positive meniscus lens element 22 and the negative meniscus lens element 23 are aspherical plastic lens elements having an aspherical surface on each side. A diaphragm S (surface No. 7) is provided so as to be positioned on an orthogonal plane, with respect to that optical axis, which is tangent to the surface on the object side of the second lens group G2 (positive meniscus lens element 21). The diaphragm S moves integrally with the second lens group G2 during zooming.

The third lens group G3 (surface Nos. 14 and 15) is configured of a single biconvex positive lens element 31. This biconvex positive lens element 31 is provided with an aspherical surface on each side thereof. An optical filter OP (surface Nos. 16 and 17) and a cover glass CG (surface Nos. 18 and 19) are provided behind (and in front of an imaging plane I) the third lens group G3 (biconvex positive lens element 31).

TABLE 1
SURFACE DATA

| Surf. No. | r | d | Nd | νd |
|---|---|---|---|---|
| 1 | −73.844 | 0.800 | 1.77250 | 49.6 |
| 2 | 10.815 | 0.402 | | |
| 3 * | 14.173 | 1.000 | 1.54358 | 55.7 |
| 4 * | 5.453 | 1.851 | | |
| 5 * | 8.881 | 2.465 | 1.63550 | 23.9 |
| 6 | 34.224 | d6 | | |
| 7(Diaphragm) | ∞ | 0.000 | | |
| 8 | 6.072 | 1.780 | 1.49700 | 81.6 |
| 9 | 1451.958 | 0.100 | | |
| 10 * | 6.317 | 1.516 | 1.54358 | 55.7 |
| 11 * | 53.810 | 0.190 | | |
| 12 * | 12.908 | 1.066 | 1.63550 | 23.9 |
| 13 * | 3.835 | d13 | | |
| 14 * | 27.347 | 1.900 | 1.54358 | 55.7 |
| 15 * | −18.404 | d15 | | |
| 16 | ∞ | 0.350 | 1.51633 | 64.1 |
| 17 | ∞ | 0.510 | | |
| 18 | ∞ | 0.500 | 1.51633 | 64.1 |
| 19 | ∞ | — | | |

The asterisk (*) designates an aspherical surface which is rotationally symmetrical with respect to the optical axis.

TABLE 2
ZOOM LENS SYSTEM DATA
Zoom Ratio 5.80

| | Short Focal Length | Intermediate | Long Focal Length |
|---|---|---|---|
| | Extremity | Focal Length | Extremity |
| FNO. | 3.4 | 5.6 | 6.5 |
| f | 4.18 | 11.40 | 24.23 |
| W | 44.5 | 18.8 | 9.1 |
| Y | 3.49 | 3.88 | 3.88 |
| fB | 0.59 | 0.59 | 0.60 |
| L | 42.02 | 36.29 | 46.01 |
| d6 | 20.500 | 5.611 | 1.105 |
| d13 | 2.589 | 12.363 | 27.875 |
| d15 | 3.915 | 3.297 | 2.000 |

TABLE 3
Aspherical Surface Data (the aspherical surface
coefficients not indicated are zero (0.00)):

| Surf. No. | K | A4 | A6 | A8 |
|---|---|---|---|---|
| 3 | 0.000 | 0.1182E−03 | 0.3730E−05 | 0.4599E−07 |
| 4 | −0.553 | −0.6877E−04 | −0.2883E−04 | 0.7637E−06 |
| 5 | 0.000 | 0.2414E−04 | −0.1938E−04 | 0.3824E−06 |
| 10 | 0.000 | −0.1016E−02 | −0.5030E−04 | |
| 11 | 0.000 | −0.1340E−02 | 0.3209E−05 | |
| 12 | 0.000 | 0.3282E−04 | −0.7353E−04 | |
| 13 | 0.000 | 0.1661E−02 | −0.1415E−03 | |
| 14 | 0.000 | 0.4757E−03 | −0.7039E−05 | 0.8467E−06 |
| 15 | 0.000 | 0.7664E−03 | −0.2435E−04 | 0.1460E−05 |

TABLE 4
LENS GROUP DATA

| Lens Group | 1^{st} Surf. | Focal Length |
|---|---|---|
| 1 | 1 | −12.65 |
| 2 | 8 | 11.31 |
| 3 | 14 | 20.54 |

### Embodiment 2

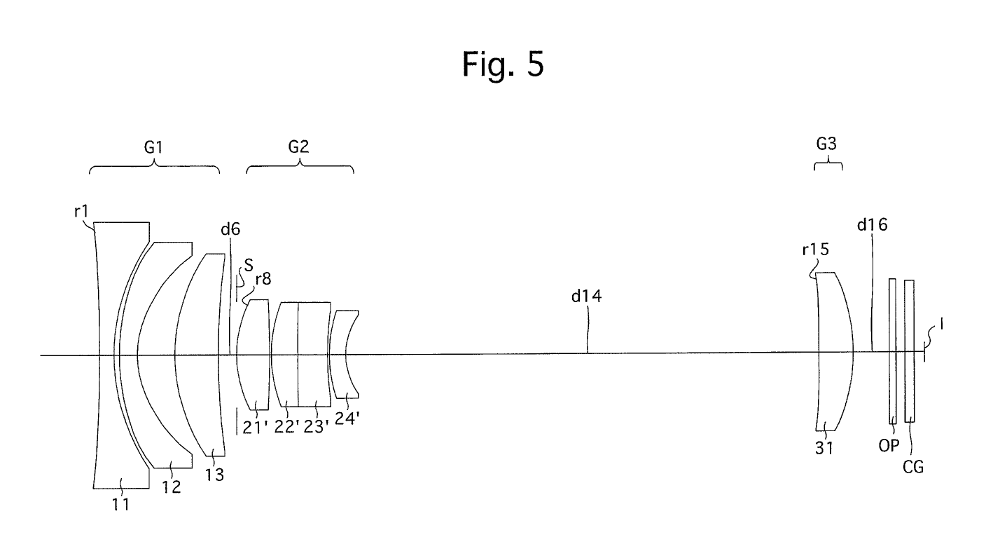

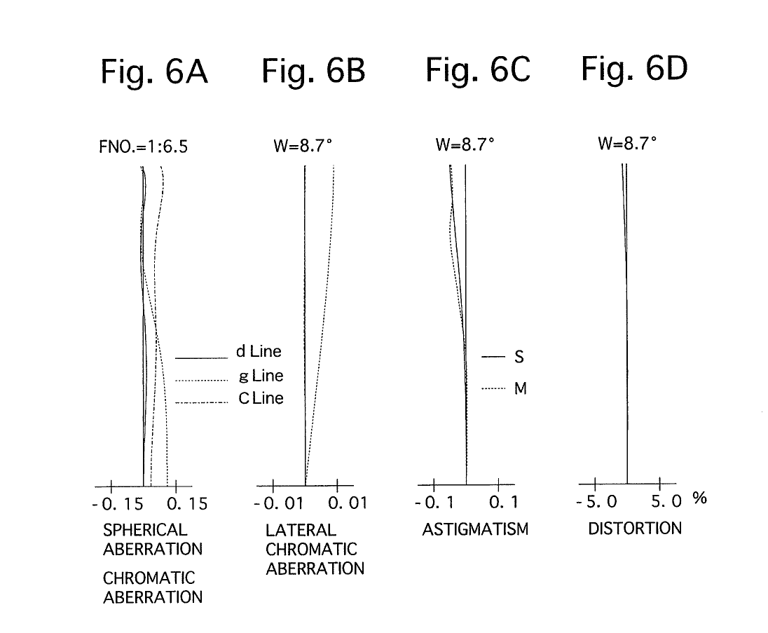

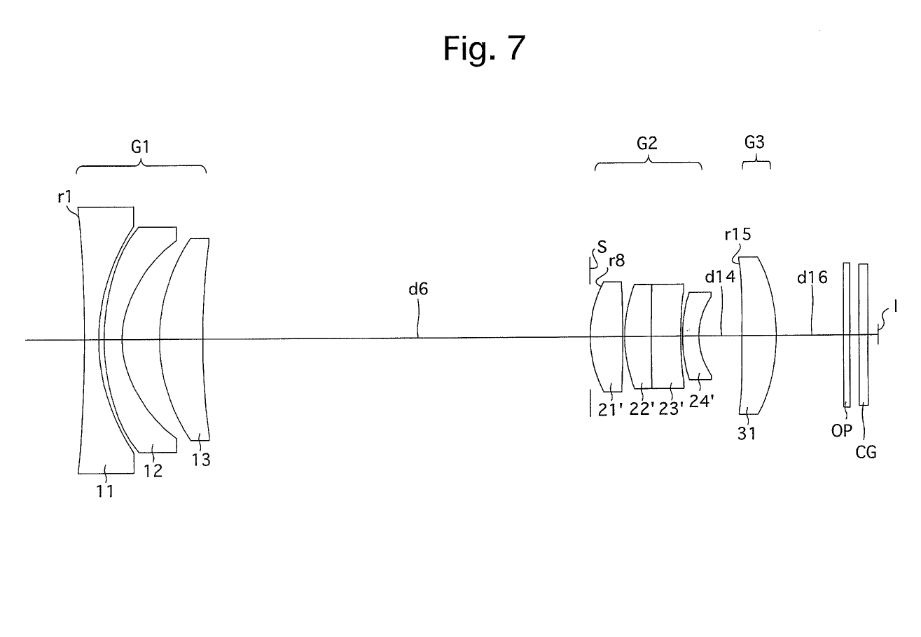

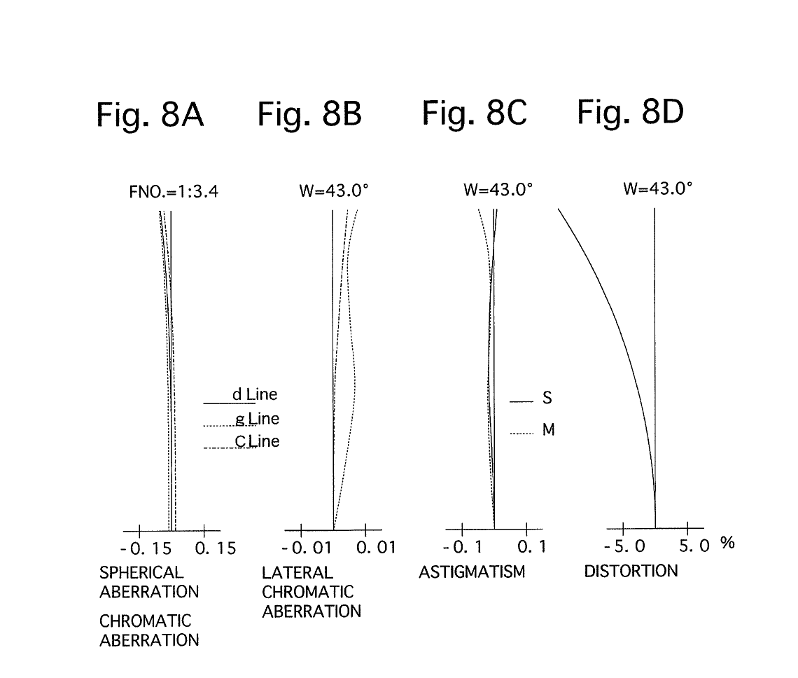

FIGS. 5 through 8D and Tables 5 through 8 show a second numerical embodiment of a zoom lens system according to the present invention. FIG. 5 shows a lens arrangement of the second numerical embodiment of the zoom lens system at the long focal length extremity when focused on an object at infinity. FIGS. 6A, 6B, 6C and 6D show various aberrations that occurred in the lens arrangement shown in FIG. 5. FIG. 7 shows a lens arrangement of the second numerical embodiment of the zoom lens system at the short focal length extremity when focussed on an object at infinity. FIGS. 8A, 8B, 8C and 8D show various aberrations that occurred in the lens arrangement shown in FIG. 7. Table 5 shows the lens surface data, Table 6 shows various zoom lens system data, Table 7 shows the aspherical surface data, and Table 8 shows the lens group data of the zoom lens system according to the second numerical embodiment.

The lens arrangement of the second numerical embodiment is the same as that of the first numerical embodiment except for the aspects mentioned hereinbelow.
(1) The second lens group G2 is configured of a biconvex positive lens element 21′, a cemented lens formed from a positive meniscus lens element 22′ having a convex surface on the object side and a negative meniscus lens element 23′ having a convex surface on the object side, and a negative meniscus lens element 24′ having a convex surface on the object side, in that order from the object side. The biconvex positive lens element 21′ is a glass lens element formed from a specialized low-dispersion glass (ED glass) having an Abbe number with respect to the d-line exceeding 80. The positive meniscus lens element 22′ is a plastic aspherical lens element having an aspherical surface on the object side. The negative meniscus lens element 23′ is a plastic aspherical lens element having an aspherical surface on the image side. The negative meniscus lens element 24′ is a plastic aspherical lens element having an aspherical surface on the image side.
(2) The positive lens element 31 of the third lens group G3 is a positive meniscus lens element having a convex surface on the image side.

TABLE 5
SURFACE DATA

| Surf. No. | r | d | Nd | νd |
|---|---|---|---|---|
| 1 | −78.697 | 0.800 | 1.78338 | 48.2 |
| 2 | 11.447 | 0.300 | | |
| 3 * | 12.935 | 1.000 | 1.54358 | 55.7 |
| 4 * | 5.549 | 2.118 | | |
| 5 * | 10.089 | 2.412 | 1.63548 | 23.9 |
| 6 | 42.275 | d6 | | |
| 7(Diaphragm) | ∞ | 0.000 | | |
| 8 | 6.831 | 1.826 | 1.49700 | 81.6 |
| 9 | −65.332 | 0.100 | | |
| 10 * | 7.812 | 1.488 | 1.54358 | 55.7 |
| 11 | 335.004 | 1.648 | 1.63548 | 23.9 |
| 12 * | 25.810 | 0.100 | | |
| 13 | 8.278 | 0.905 | 1.63548 | 23.9 |
| 14 * | 3.795 | d14 | | |
| 15 * | −153.249 | 1.900 | 1.54358 | 55.7 |
| 16 * | −10.517 | d16 | | |
| 17 | ∞ | 0.350 | 1.51633 | 64.1 |
| 18 | ∞ | 0.510 | | |
| 19 | ∞ | 0.500 | 1.51633 | 64.1 |
| 20 | ∞ | — | | |

The asterisk (*) designates an aspherical surface which is rotationally symmetrical with respect to the optical axis.

TABLE 6
ZOOM LENS SYSTEM DATA
Zoom Ratio 5.80

| | Short Focal Length | Intermediate | Long Focal Length |
|---|---|---|---|
| | Extremity | Focal Length | Extremity |
| FNO. | 3.4 | 4.3 | 6.5 |
| f | 4.40 | 11.40 | 25.52 |
| W | 43.0 | 18.8 | 8.7 |
| Y | 3.49 | 3.88 | 3.88 |
| fB | 0.59 | 0.59 | 0.59 |
| L | 44.30 | 36.80 | 46.01 |
| d6 | 21.611 | 6.116 | 1.019 |
| d14 | 2.418 | 10.642 | 26.433 |
| d16 | 3.719 | 3.489 | 2.003 |

TABLE 7
Aspherical Surface Data (the aspherical surface
coefficients not indicated are zero (0.00)):

| Surf. No. | K | A4 | A6 | A8 | A10 |
|---|---|---|---|---|---|
| 3 | 0.000 | −0.7517E−04 | 0.5382E−05 | 0.1041E−07 | |
| 4 | −0.613 | −0.1105E−03 | −0.1666E−04 | 0.5306E−06 | |
| 5 | 0.000 | 0.9689E−04 | −0.1260E−04 | 0.2655E−06 | |
| 10 | 0.000 | −0.4139E−03 | 0.8060E−05 | | |
| 12 | 0.000 | 0.5767E−03 | 0.6465E−04 | | |
| 14 | 0.000 | −0.4594E−03 | −0.1005E−03 | | |
| 15 | 0.000 | −0.1260E−03 | −0.7524E−05 | 0.1746E−06 | −0.2086E−07 |
| 16 | 0.000 | 0.2407E−03 | −0.2441E−04 | 0.9061E−06 | −0.2853E−07 |

TABLE 8
LENS GROUP DATA

| Lens Group | 1^{st} Surf. | Focal Length |
|---|---|---|
| 1 | 1 | −13.30 |
| 2 | 8 | 11.32 |
| 3 | 15 | 20.68 |

### Embodiment 3

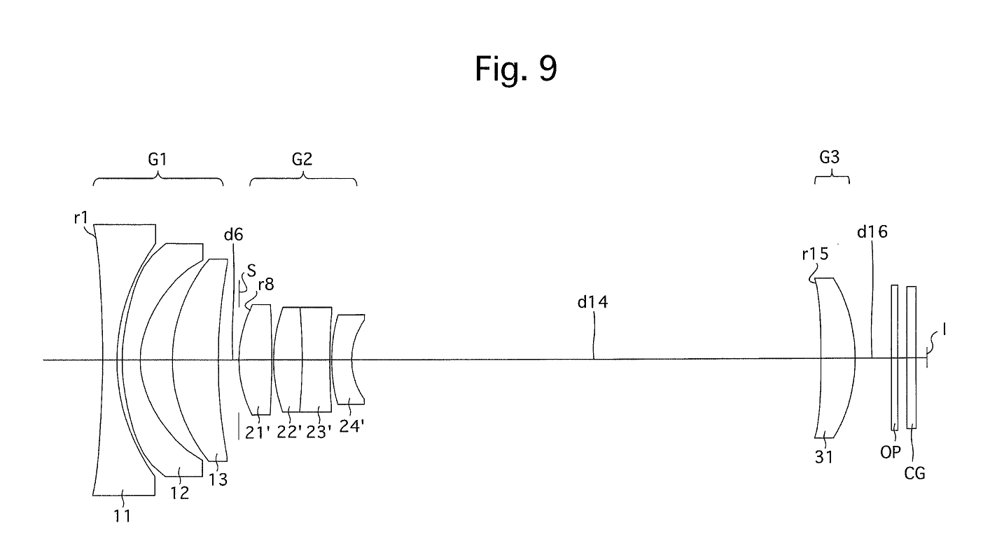

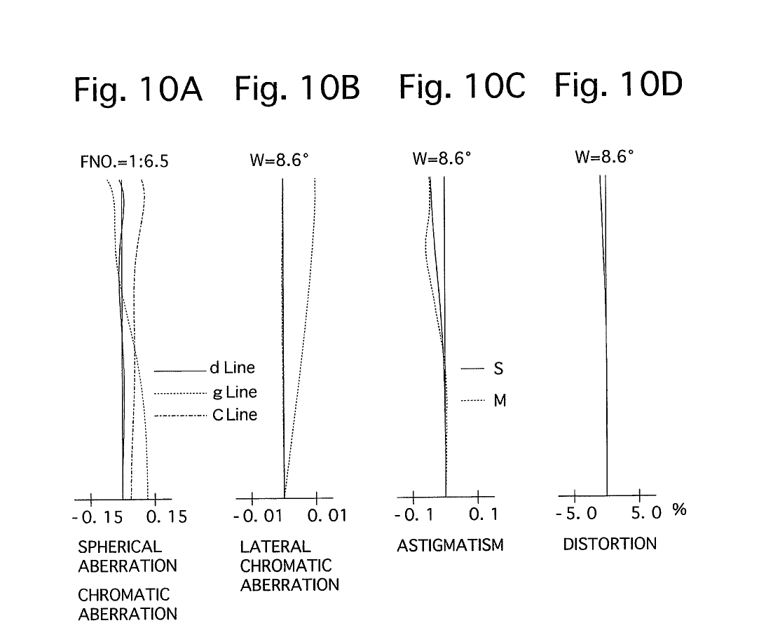

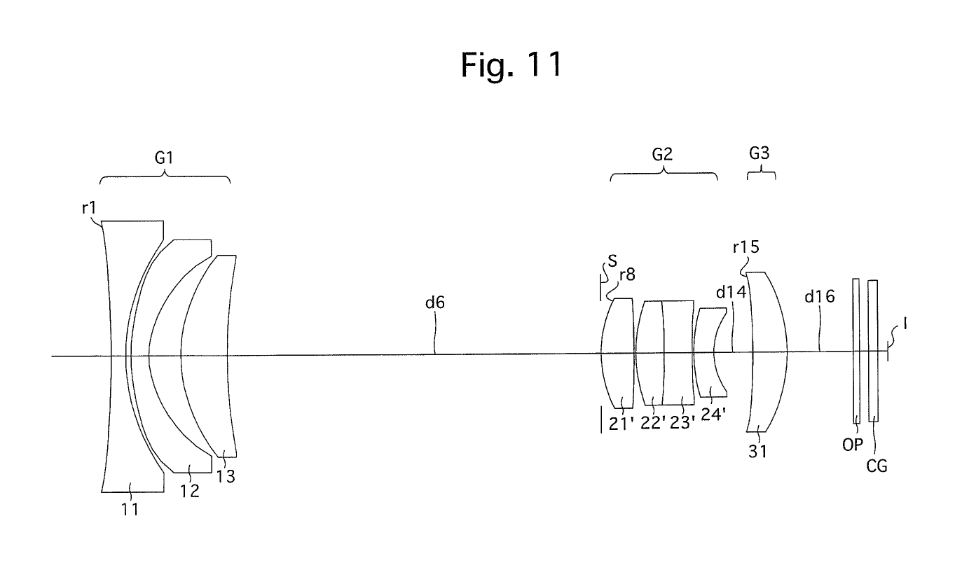

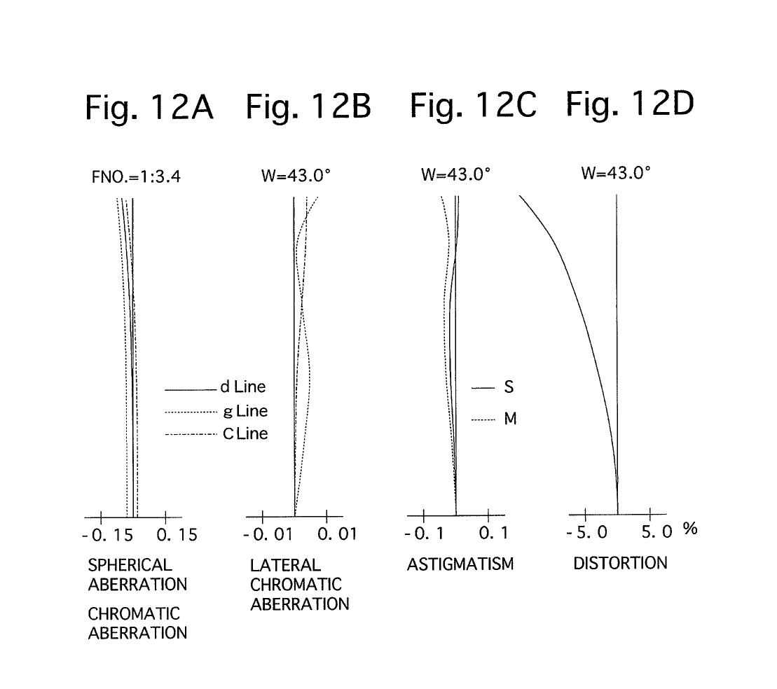

FIGS. 9 through 12D and Tables 9 through 12 show a third numerical embodiment of a zoom lens system according to the present invention. FIG. 9 shows a lens arrangement of the third numerical embodiment of the zoom lens system at the long focal length extremity when focused on an object at infinity. FIGS. 10A, 10B, 100 and 10D show various aberrations that occurred in the lens arrangement shown in FIG. 9. FIG. 11 shows a lens arrangement of the third numerical embodiment of the zoom lens system at the short focal length extremity when focussed on an object at infinity. FIGS. 12A, 12B, 12C and 12D show various aberrations that occurred in the lens arrangement shown in FIG. 11. Table 9 shows the lens surface data, Table 10 shows various zoom lens system data, Table 11 shows the aspherical surface data, and Table 12 shows the lens group data of the zoom lens system according to the third numerical embodiment.

The lens arrangement of the third numerical embodiment is the same as that of the second numerical embodiment except for the aspects mentioned hereinbelow.
(1) The biconvex negative lens element 11 of the first lens group G1 is an aspherical lens element having an aspherical surface on the object side.
(2) The positive lens element 22′ of the second lens group G2 is a biconvex positive lens element and the negative lens element 23′ of the second lens group G2 is a biconcave negative lens element.

TABLE 9
SURFACE DATA

| Surf. No. | r | d | Nd | νd |
|---|---|---|---|---|
| 1 * | −46.303 | 0.800 | 1.70058 | 56.2 |
| 2 | 11.179 | 0.300 | | |
| 3 * | 10.738 | 1.000 | 1.54358 | 55.7 |
| 4 * | 4.946 | 1.821 | | |
| 5 * | 8.594 | 2.570 | 1.60641 | 27.2 |
| 6 | 30.340 | d6 | | |
| 7 (Diaphragm) | ∞ | 0.000 | | |
| 8 | 6.884 | 1.834 | 1.49700 | 81.6 |
| 9 | −53.334 | 0.100 | | |
| 10 * | 8.407 | 1.584 | 1.54358 | 55.7 |
| 11 | −30.486 | 1.542 | 1.60641 | 27.2 |
| 12 * | 70.387 | 0.100 | | |
| 13 | 9.378 | 1.111 | 1.60641 | 27.2 |
| 14 * | 3.729 | d14 | | |
| 15 * | −44.902 | 1.900 | 1.54358 | 55.7 |
| 16 * | −8.815 | d16 | | |
| 17 | ∞ | 0.350 | 1.51633 | 64.1 |
| 18 | ∞ | 0.510 | | |
| 19 | ∞ | 0.500 | 1.51633 | 64.1 |
| 20 | ∞ | — | | |

The asterisk (*) designates an aspherical surface which is rotationally symmetrical with respect to the optical axis.

TABLE 10
ZOOM LENS SYSTEM DATA
Zoom Ratio 5.90

| | Short Focal Length | Intermediate | Long Focal Length |
|---|---|---|---|
| | Extremity | Focal Length | Extremity |
| FNO. | 3.4 | 5.4 | 6.5 |
| f | 4.40 | 11.40 | 25.96 |
| W | 43.0 | 18.7 | 8.6 |
| Y | 3.49 | 3.88 | 3.88 |
| fB | 0.59 | 0.59 | 0.59 |
| L | 43.27 | 36.44 | 46.00 |
| d6 | 20.819 | 6.118 | 1.159 |
| d14 | 2.175 | 10.329 | 26.231 |
| d16 | 3.661 | 3.382 | 1.998 |

TABLE 11
Aspherical Surface Data (the aspherical surface
coefficients not indicated are zero (0.00)):

| Surf. No. | K | A4 | A6 | A8 | A10 |
|---|---|---|---|---|---|
| 1 | 0.000 | 0.1682E−03 | −0.2620E−05 | −0.3736E−08 | 0.1209E−09 |
| 3 | 0.000 | −0.8204E−03 | 0.1969E−04 | 0.2852E−07 | |
| 4 | −1.000 | −0.2487E−03 | −0.9045E−05 | 0.7841E−06 | |
| 5 | 0.000 | 0.9730E−04 | −0.1813E−04 | 0.3450E−06 | |
| 10 | 0.000 | −0.4935E−03 | 0.9740E−05 | | |
| 12 | 0.000 | 0.6607E−03 | 0.4951E−04 | | |
| 14 | 0.000 | −0.8768E−03 | −0.9249E−04 | | |
| 15 | 0.000 | −0.2057E−03 | 0.1858E−05 | 0.2336E−07 | −0.2414E−07 |
| 16 | 0.000 | 0.2810E−03 | −0.1547E−04 | 0.8145E−06 | −0.3204E−07 |

TABLE 12
LENS GROUP DATA

| Lens Group | 1^{st} Surf. | Focal Length |
|---|---|---|
| 1 | 1 | −13.02 |
| 2 | 8 | 10.97 |
| 3 | 15 | 19.81 |

The numerical values of each condition for each embodiment are shown in Table 13.

TABLE 13

| | Embod. 1 | Embod. 2 | Embod. 3 |
|---|---|---|---|
| Cond. (1) | 0.01 | 0.01 | 0.01 |
| Cond. (2) | 0.0227 | 0.0217 | 0.0207 |
| Cond. (3) | −6.83 | −6.87 | −4.14 |

As can be understood from Table 13, the first through third numerical embodiments satisfy conditions (1) through (3). Furthermore, as can be understood from the aberration diagrams, the various aberrations are favorably corrected.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A zoom lens system comprising a negative first lens group, a positive second lens group, and a positive third lens group, in that order from the object side,
wherein, upon zooming from the short focal length extremity to the long focal length extremity, the first through third lens groups move along an optical axis direction so that the distance between said first lens group and said second lens group decreases, and the distance between said second lens group and said third lens group increases,
wherein said first lens group includes a negative glass lens element and at least two plastic lens elements, in that order from the object side, and wherein the following condition (1) is satisfied:

|f1/f1pc|<0.04 (1), wherein
f1 designates the focal length of said first lens group, and
f1pc designates the combined focal length of said plastic lens elements that are provided within said first lens group.

2. The zoom lens system according to claim 1, wherein the following condition (2) is satisfied:
0.015<Σ(φ1i/v1i)<0.025 (2), wherein
φ1i designates the refractive power (=1/f1i) of the i^{th} lens element of the plastic lens elements which are provided in said first lens group,
v1i designates the Abbe number with respect to the d-line of the i^{th} lens element of the plastic lens elements which are provided in said first lens group, and
f1i designates the focal length of the i^{th} lens element of the plastic lens elements which are provided in said first lens group.

3. The zoom lens system according to claim 1, wherein said first lens group comprises a negative glass lens element, a negative plastic lens element, and a positive plastic lens element, in that order from the object side, wherein the following condition (3) is satisfied:
−8.0<R1/R2<−3.0 (3), wherein
R1 designates the radius of curvature of the surface on the object side of the glass lens element which is provided closest to the object side within said first lens group, and
R2 designates the radius of curvature of the surface on the image side of the glass lens element which is provided closest to the object side within said first lens group.
